(19) United States
(12) Patent Application Publication
(10) Pub. No.: US 2025/0017234 A1
(43) Pub. Date: Jan. 16, 2025

(54) COFFEE GROUND DERIVED MICROBOTS

(71) Applicant: GEORGE MASON UNIVERSITY, Fairfax, VA (US)

(72) Inventors: Amit Kumar Singh, Fairfax, VA (US); Tarini Basireddy, Fairfax, VA (US); Jeffrey Lawrence Moran, Fairfax, VA (US)

(21) Appl. No.: 18/768,911

(22) Filed: Jul. 10, 2024

Related U.S. Application Data
(60) Provisional application No. 63/512,744, filed on Jul. 10, 2023.

(51) Int. Cl. A23F 5/14; B25J 7/00

(52) U.S. Cl. CPC A23F 5/14; B25J 7/00; A23F 2200/00

(57) ABSTRACT

The disclosed technology can generally relate to methods for manufacturing spent coffee ground derived microbots for purifying contaminated water sources. The method for manufacturing the spent coffee ground derived microbots can include obtaining coffee grounds, magnetizing the coffee grounds, and coating the magnetized coffee ground with ascorbic acid. Magnetizing the coffee grounds can include immersing the coffee ground in a solution of iron oxide nanoparticles and ethanol, mixing the coffee grounds and the solution, and allowing the coffee grounds and the solution to sit undisturbed for a predetermined period.

### CROSS-REFERENCE TO RELATED APPLICATIONS

This application claims the benefit of, and priority to, U.S. Provisional Patent App. No. 63/512,744, filed on Jul. 10, 2023, and entitled “COFFEE GROUND DERIVED MICROBOTS,” the disclosure of which is incorporated by reference in its entirety as if the same were fully set forth herein.

### TECHNICAL FIELD

This application generally relates to systems and methods for creating microbots and, more specifically, to creating microbots from spent coffee grounds for use in water treatment applications.

### BACKGROUND

Water pollution is one of the most pressing environmental issues faced by modern civilization, as the past few decades have seen an increase in anthropogenic water contamination. Water pollutants from agricultural runoff, industrial waste, and sewage have increased water-borne diseases and health issues. These contaminants can also disrupt marine ecosystems, leading to declining biodiversity. Water contaminants adversely affect aquatic flora and fauna, impairing photosynthesis and increasing chemical oxygen demand. Moreover, uncontrolled discharge of polluted effluent into marine ecosystems can result in bioaccumulation that poses a threat to human health.

Among the various water pollutants, soluble organic dyes pose a significant hazard to water quality because they are generally toxic, non-biodegradable, and readily dispersed in water. The textile, leather, paints and pigments, plastics, paper, food, and cosmetic industries discharge significant quantities of effluents containing dyes into rivers and lakes. In addition to endangering aquatic ecosystems, some of these dye pollutants have long-term mutagenic and carcinogenic effects on humans.

Along with industrial dye pollutants, the prevalence of microplastics (MPs) in water bodies has gained attention in recent years. MPs are microscopic particulates less than five millimeters in size that originate primarily from the fragmentation of larger plastic objects and personal care products. MPs are capable of withstanding environmental stress, allowing them to endure and persist in aquatic environments for up to several hundred years. Additionally, MPs are capable of adsorbing hydrophobic organic compounds and heavy metals, facilitating their transportation across different locations. In recent times, microplastics have penetrated the food chain, and researchers have uncovered their presence in various parts of human bodies, including the lungs, placenta, breast milk, and blood capillaries.

Alongside industrial dyes and MPs, oil spills constitute a substantial cause of water contamination. Oil spillage in water can occur because of offshore drilling activities, distribution pipelines located underwater, or shipwrecks. As floating oil droplets coalesce at the water's surface, they form a thick film, blocking sunlight penetration and oxygen exchange, affecting the delicate balance that aquatic life needs to flourish. Oil spillage has a significant impact on the world economy, including damage to local habitats, reduction of fishery resources, and decline in tourism activities.

At present, water purification facilities employ expensive techniques, which include filtration, flocculation, membrane-based separation processes, adsorption, activated sludge techniques, and coagulation methods to separate water impurities. Despite attempts to mitigate water pollution through various processes, the complete elimination of all pollutants from effluents remains a challenging task. The conventional techniques of treating wastewater also have their shortcomings, including the need for substantial land area, high energy consumption, and frequent maintenance. Most developing countries lack access to potable water due to a dearth of affordable water treatment techniques. The limitations of the wastewater treatment process have prompted researchers to investigate affordable approaches for efficient water purification.

Water treatment with self-propelled microbots has gained traction in recent years. Microbots can include miniature machines that transform external sources of energy, such as chemical reactions, light, sound, or gradients of magnetic field, electric potential, or temperature into motion. Using magnetic fields or ultrasonic waves, these minute devices can be steered remotely to capture targeted pollutants present in water bodies. Microbots offer various benefits over conventional water treatment techniques such as cost-effectiveness, efficient payload release, enhanced mass transfer of pollutants to the catalyst surface, and accelerated detoxification of water. In recent times, microbots have shown promising results in efficiently removing different forms of water pollutants, which include but are not limited to microplastics, oil spillage, industrial dyes, heavy metals, antibiotics, endocrine disruptors, nerve agents, as well as combating water-borne pathogens. With that said, there are few known microbots that are derived from readily available, affordable, and sustainable materials. Additionally, there is still a lack of a cost-effective manner to render sustainable microbots amenable to magnetic manipulation and steering to enhance their degradation performance and enable magnetic recollection upon completion.

Therefore, there is a long-felt but unresolved need for a system or method for producing microbots for the purpose of cleaning water supplies using sustainable, low-cost materials that can be amenable to magnetic manipulation and steering to enhance their degradation performance and enable magnetic recollection upon cleaning a particular water supply.

### BRIEF SUMMARY OF THE DISCLOSURE

Briefly described, and according to one example, aspects of the present disclosure generally relate to methods for fabricating coffee ground-based microbots from hydrophobic spent coffee grounds (“SCGs”) using a green chemistry approach. Coffee ground-based microbots, as described herein, generally include the result of the processes described herein in which coffee grounds (or other similar organic material) are processed such that the coffee grounds have magnetized capabilities to assist with the removal of certain materials (e.g., contaminants, pollutants) from water or other aqueous solutions. In one example, the green chemistry approach can include acquiring SCGs from a coffee maker and combining the SCGs with iron oxide nanoparticles (“IONPs”) in an absolute ethanol suspension to create coffee-ground-based microbots. The green chemistry approach can produce coffee-ground-based microbots with temperatures below 140 degrees Celsius, reducing the need of specialized equipment and the overall carbon footprint of the process. The green chemistry approach can further produce coffee-ground-based microbots without the need of toxic chemicals, which can cause additional damages to the environment and unnecessary waste.

The coffee-ground-based microbots can exhibit magnetic properties, due to the IONPs, to facilitate movements in a liquid. The coffee-ground-based microbots can function as a cleaning agent used to collect and remove oil droplets, oil slicks, and/or microplastics from contaminated water sources. According to another example, the coffee-ground-based microbots can be combined with ascorbic acid (“AA”) to remove industrial and/or organic dyes from contaminated water sources. The coffee-ground-based microbots can be used in various applications to treat contaminated water supplies. Due to their wide availability, SCG bio-wastes can be a convenient and cost-effective starting material for making coffee-ground-based microbots.

The SCGs can include ground coffee that has undergone a coffee brewing process and can mainly be composed of cellulose, lignocellulose, and organic compounds, such as lipids, amino acids, polyphenols, caffeine, melanoidins, and polysaccharides. On obtaining the SCGs, the SCGs can be dried to completely remove water content. An ethanol medium can be used to functionalize unmodified SCGs (also referred to herein as SCGs, hydrophobic SCGs, low-density SCGs, etc.) with IONPs. The disclosed techniques can include submerging all low-density dried SCG particulates in an absolute ethanol and IONP solution. For example, the disclosed techniques can include suspending the SCGs in the ethanolic IONPs solution undisturbed for at least 2 hours at room temperature. By suspending the SCGs in the ethanolic IONPs solution, the SCGs can form a hydrogen bond with the IONPs. For example, the SCGs can interact with the IONPs by forming a hydrogen bond formation between the hydroxyl (—OH) functional groups of SCGs and oxygen entities of the IONPs. The hydrogen bond formation can lead to a stable immobilization of the IONPs on the surface of the SCGs. On forming a hydrogen bond with the IONPs, the magnetic SCGs can exhibit magnetic properties. For example, the magnetic SCGs can exhibit magnetic properties, such as magnetic attraction. The magnetic actuation of the magnetic SCGs can facilitate precise manipulation, navigation, and retrieval of the magnetic SCGs from a particular liquid source. For example, the magnetic SCGs can be magnetically retrieved at the end of the reaction using a magnet or electromagnet. In another example, the magnetic properties of the magnetic SCGs can facilitate the recovery of the magnetic SCGs after wastewater treatment.

The magnetic SCGs can effectively restore polluted seawater through the elimination of organic dyes, microplastics, and oil spills. The magnetic SCGs can be hydrophobic, which can enable the magnetic SCGs to easily interact with microplastics and oil droplets. The magnetic SCGs can capture, transport, and eliminate polystyrene (PS) microbeads as well as oil droplets that are suspended in seawater. The magnetic SCGs can accomplish the capture, transportation, and elimination of polystyrene (PS) microbeads and other materials using both the hydrophobic qualities of the SCGs alongside the magnetic nature of IONPs. The magnetic SCGs can be modified with AA to facilitate the chemical reduction of water-soluble methylene blue (MB) dye pollutants present in seawater. For example, after the creation of the magnetic SCGs, the magnetic SCGs can be suspended in AA, and oven-dried to form AA-based magnetic SCGs. The AA-based magnetic SCGs can be introduced to contaminated water supplies to remove dye pollutants.

The magnetic SCGs can incorporate low-cost SCGs and biocompatible vitamin C or AA into a micro-robotic framework as a novel approach for water treatment. The disclosed techniques can include a green chemistry approach, as discussed herein, to introduce unmodified IONPs into SCG wastes at room temperature. Consequently, magnetic SCGs can be obtained without requiring any chemical reactions or high temperature procedures. The magnetic SCGs can employ their hydrophobic properties, without the need for extra chemical modifications or carbonization at high temperatures, to eliminate oil spills and microplastics. The magnetic SCGs can include multi-functional capabilities for water purification, including the ability to eradicate dye pollutants, oil spillage removal, and trapping of MPs contaminants.

According to a first aspect, a method, comprising: A) obtaining coffee grounds; B) magnetizing the coffee grounds; and C) coating the magnetized coffee grounds with ascorbic acid.

According to a further aspect, the method of the first aspect or any other aspect, wherein magnetizing the coffee grounds comprises: A) immersing the coffee grounds in a solution of iron oxide nanoparticles and ethanol; B) mixing the coffee grounds and the solution; and C) allowing the coffee grounds and the solution to sit undisturbed for a predetermined time period.

According to a further aspect, the method of the first aspect or any other aspect, wherein: A) the coffee grounds comprise about 200 milligrams by weight; and B) the solution comprises about 6 milliliters of the ethanol and about 80 milligrams of the iron oxide nanoparticles.

According to a further aspect, the method of the first aspect or any other aspect, further comprising: A) straining the magnetized coffee grounds from the solution; B) washing the magnetized coffee grounds with an ethanol wash; C) suspending the magnetized coffee grounds in an ethanol solution; and D) retrieving the magnetized coffee grounds with a magnetic force, wherein the magnetic force interacts with the iron oxide nanoparticles.

According to a further aspect, the method of the first aspect or any other aspect, further comprising: A) prior to magnetizing the coffee grounds, grinding the coffee grounds to a size between about 300 micrometers and about 450 micrometers; and B) drying the coffee grounds at about 140 degrees Celsius for at least 24 hours.

According to a further aspect, the method of the first aspect or any other aspect, wherein coating the magnetized coffee grounds with ascorbic acid comprises: A) dissolving ascorbic acid in a solution of water and ethanol; and B) immersing the magnetized coffee grounds in the solution.

According to a further aspect, the method of the first aspect or any other aspect, wherein: A) the ascorbic acid comprises about 200 milligrams by weight; B) the solution comprising about 5 milliliters of the water and about 5 milliliters of the ethanol; and C) the magnetized coffee grounds comprise about 60 milligrams by weight.

According to a further aspect, the method of the first aspect or any other aspect, further comprising drying the magnetized coffee grounds at about 65 degrees Celsius for at least 12 hours.

According to a further aspect, the method of the first aspect or any other aspect, wherein the coffee grounds comprise spent coffee grounds that have undergone a coffee brewing process.

According to a second aspect, a composition, comprising: A) coffee grounds and iron oxide nanoparticles, wherein the coffee grounds are coated in ascorbic acid.

According to a further aspect, the composition of the second aspect or any other aspect, wherein the coffee grounds are bonded to the iron oxide nanoparticles by hydrogen bonds.

According to a further aspect, the composition of the second aspect or any other aspect, wherein the composition is produced by a process of: A) obtaining the coffee grounds comprising spent coffee grounds that have undergone a coffee brewing process; B) magnetizing the coffee grounds with the iron oxide nanoparticles; and C) coating the magnetized coffee grounds with the ascorbic acid.

According to a further aspect, the composition of the second aspect or any other aspect, wherein the composition is produced by the process of: A) prior to magnetizing the coffee grounds, grinding the coffee grounds to a size between about 300 micrometers and about 450 micrometers; and B) drying the coffee grounds at about 140 degrees Celsius for at least 24 hours.

According to a further aspect, the composition of the second aspect or any other aspect, wherein coating the magnetized coffee grounds with the ascorbic acid by: A) dissolving the ascorbic acid in a solution of water and ethanol; and B) immersing the magnetized coffee grounds in the solution.

According to a further aspect, the composition of the second aspect or any other aspect, wherein the coffee grounds are configured to remove at least one contaminant from an aqueous solution by causing movement of the coffee grounds in the aqueous solution using a magnetized force.

According to a third aspect, a method of using magnetized coffee grounds to remove at least one contaminant from an aqueous solution comprising: A) obtaining the magnetized coffee grounds comprising coffee grounds bonded to iron oxide nanoparticles; B) immersing the magnetized coffee grounds in the aqueous solution comprising the at least one contaminant; and C) removing the at least one contaminant from the aqueous solution by causing movement of the magnetized coffee grounds in the aqueous solution using a magnetized force.

According to a further aspect, the method of the third aspect or any other aspect, wherein the at least one contaminant comprises an oil or a microplastic.

According to a further aspect, the method of the third aspect or any other aspect, wherein the magnetized force interacts with the iron oxide nanoparticles.

According to a further aspect, the method of the third aspect or any other aspect, wherein the magnetized coffee grounds are coated in ascorbic acid and the at least one contaminant comprises a dye.

According to a further aspect, the method of the third aspect or any other aspect, wherein coffee grounds comprise spent coffee grounds that have undergone a coffee brewing process.

These and other aspects, features, and benefits of the claimed innovation(s) will become apparent from the following detailed written description of the preferred examples and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more examples and/or aspects of the disclosure and, together with the written description, serve to explain the principles of the disclosure. Wherever possible, the same reference numbers are used throughout the drawings to refer to the same or like elements of the disclosed systems and processes, and wherein:

FIG. 1 illustrates an example technique for creating magnetic SCGs, according to one example of the disclosed technology;

FIG. 2 illustrates an example technique for creating ascorbic-acid-based magnetic SCGs, according to one example of the disclosed technology;

FIG. 3 illustrates an example use case scenario of the magnetic SCGs, according to one example of the disclosed technology;

FIG. 4 illustrates an example use case scenario of the ascorbic-acid-based magnetic SCGs, according to one example of the disclosed technology; and

FIG. 5 illustrates a flowchart of a process for creating the magnetic SCGs and the ascorbic-acid-based magnetic SCGs, according to one example of the disclosed technology.

### DETAILED DESCRIPTION

Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

The term “about” shall be interpreted to mean proximally close to the stated number, but perhaps not exact. For example, the term “about” shall be interpreted to mean “approximately” or “reasonably close to” and include any statistically insignificant variations therefrom. In some embodiments, the term “about” could be within a 5% threshold of the total value of the described amount.

### Overview

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to methods for fabricating coffee-ground-based microbots from hydrophobic spent coffee grounds (“SCGs”) using a green chemistry approach. In one example, the green chemistry approach can include acquiring SCGs from a coffee maker and combining the SCGs with iron oxide nanoparticles (“IONPs”) in an absolute ethanol suspension to create coffee-ground-based microbots. The green chemistry approach can produce coffee-ground-based microbots with temperatures below 140 degrees Celsius, reducing the need of specialized equipment and the overall carbon footprint of the process. The green chemistry approach can further produce coffee-ground-based microbots without the need of toxic chemicals, which can cause additional damages to the environment and unnecessary waste.

The coffee-ground-based microbots can exhibit magnetic properties, due to the IONPs, to facilitate movements in a liquid. The coffee-ground-based microbots can function as a cleaning agent used to collect and remove oil particles and/or microplastics from contaminated water sources. According to another example, the coffee-ground-based microbots can be combined with ascorbic acid (“AA”) to remove industrial and/or organic dyes from contaminated water sources. The coffee-ground-based microbots can be used in various applications to treat contaminated water supplies. Due to their wide availability, SCG bio-wastes can be a convenient and cost-effective starting material for making coffee-ground-based microbots.

The SCGs can include ground coffee that has undergone a coffee brewing process and can mainly be composed of cellulose, lignocellulose, and organic compounds, such as lipids, amino acids, polyphenols, caffeine, melanoidins, and polysaccharides. On obtaining the SCGs, the SCGs can be dried to completely remove water content. For example, the SCGs can be dried in an oven at 105 degrees Celsius for 48 hours to remove an initial moisture content. Continuing this example, the SCGs can be ground to a desired size (e.g., 450 μm). Further continuing this example, the SCGs can be heated in an oven for at least about 24 hours at about 140 degrees Celsius to remove any remaining water content. In another example, the SCGs can be heated in an oven for at least about 2 hours at about 140 degrees Celsius until the SCGs are completely dehydrated. On drying the SCGs, an ethanol medium can be used to functionalize the unmodified SCGs (also referred to herein as SCGs, hydrophobic SCGs, low-density SCGs, etc.) with IONPs. The disclosed techniques can include submerging all low-density dried SCG particulates in an absolute ethanol and IONP solution. For example, the disclosed techniques can include suspending the SCGs in the ethanolic IONPs solution undisturbed for at least 2 hours at room temperature. By suspending the SCGs in the ethanolic IONPs solution, the SCGs can form a hydrogen bond with the IONPs. For example, the SCGs can interact with the IONPs by forming a hydrogen bond formation between the hydroxyl (—OH) functional groups of SCGs and oxygen entities of the IONPs. The hydrogen bond formation can lead to a stable immobilization of the IONPs on the surface of the SCGs. On forming a hydrogen bond with the IONPs, the magnetic SCGs can exhibit magnetic properties. As will be understood, prior to magnetizing the SCGs, the SCGs can include ionized properties (e.g., include an electrical charge). By bonding the SCGs with the IONPs to create the magnetic SCGs, the charge of the SCGs can increase. For example, the magnetic SCGs can exhibit magnetic properties, such as magnetic attraction. The magnetic actuation of the magnetic SCGs can facilitate precise manipulation, navigation, and retrieval of the magnetic SCGs from a particular liquid source. For example, the magnetic SCGs can be magnetically retrieved at the end of the reaction using a magnet or electromagnet. In another example, the magnetic properties of the magnetic SCGs can facilitate the recovery of the magnetic SCGs after wastewater treatment.

The magnetic SCGs can effectively restore polluted seawater through the elimination of organic dyes, microplastics, and oil spills. The magnetic SCGs can be hydrophobic, which can enable the magnetic SCGs to easily interact with microplastics and oil droplets. The magnetic SCGs can capture, transport, and eliminate polystyrene (PS) microbeads as well as oil droplets that are suspended in seawater. The magnetic SCGs can accomplish the capture, transportation, and elimination of polystyrene (PS) microbeads and other materials using both the hydrophobic qualities of the SCGs alongside the magnetic nature of IONPs. The magnetic SCGs can be modified with AA to facilitate the chemical reduction of water-soluble methylene blue (MB) dye pollutants present in seawater.

To form the AA-based magnetic SCGs, the magnetic SCGs can be suspended in an AA solution. For example, the magnetic SCGs can be combined with an AA solution including AA molecules, water, and/or ethanol. The mixture can include a non-limiting example of 200 mg of AA molecules 202 dissolved in 5 mL of DI water and 5 mL of ethanol to make a 10 mL solution of 20 mg/mL AA solution. Continuing this example, the magnetic SCGs can be immersed in the AA solution to form the AA-based magnetic SCGs. One the surface of the magnetic SCGs have an AA coating, the AA-based magnetic SCGs can be oven-dried at 65 degrees Celsius for 8 hours. Once dried the AA-based magnetic SCGs can be introduced to contaminated water supplies to remove dye pollutants.

Both the magnetic SCGs and the AA-based magnetic SCGs can undergo cleaning procedures after use for reuse in future applications. For example, the magnetic SCGs can undergo various drying and ethanol wash phases for reuse in MP recovery. In another example, the magnetic SCGs can undergo various drying and acetone wash phases for reuse in oil spill recovery.

The magnetic SCGs can incorporate low-cost SCGs and biocompatible vitamin C or AA into a micro-robotic framework as a novel approach for water treatment. The disclosed techniques can include a green chemistry approach, as discussed herein, to introduce unmodified IONPs into SCG wastes at room temperature. Consequently, magnetic SCGs can be obtained without requiring any chemical reactions or high temperature procedures. The magnetic SCGs can employ their hydrophobic properties, without the need for extra chemical modifications or carbonization at high temperatures, to eliminate oil spills and microplastics. The magnetic SCGs can include multi-functional capabilities for water purification, including the ability to eradicate dye pollutants, oil spillage removal, and trapping of MPs contaminants.

### Example Embodiments

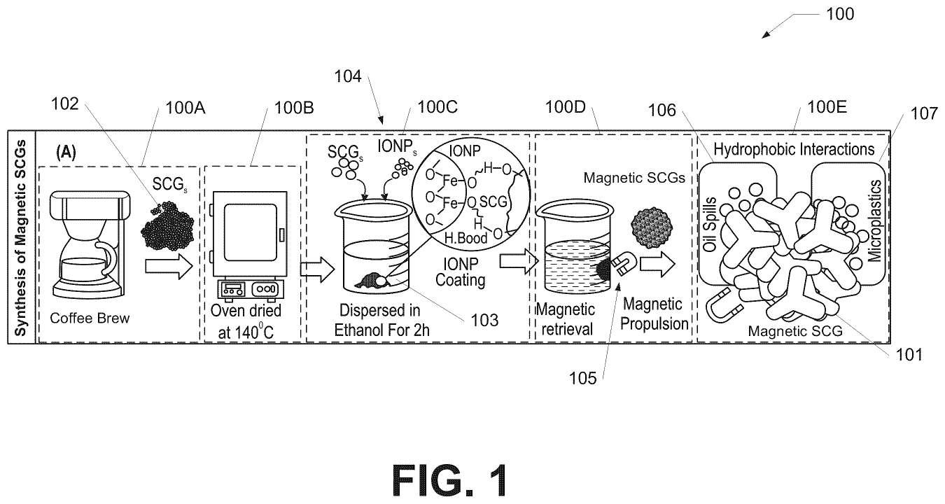

Referring now to the figures, for the purposes of example and explanation of the fundamental processes and components of the disclosed systems and processes, reference is made to FIG. 1, which illustrates a technique 100 for manufacturing magnetic spent coffee grounds (SCGs) 101, according to one or more examples. As will be understood and appreciated, the technique 100, shown in FIG. 1, represents merely one approach or example of the present system and methods, and other aspects are used according to various examples of the present system and methods.

The magnetic SCGs 101 can be defined as magnetic microbots that can remove various pollutants from a contaminated water source. As will be understood, a microbot or a micromotor can include a particle or device 1 millimeter or smaller than can be moved or manipulated by an external force (e.g., a magnetic force). For example, pollutants can include but are not limited to debris, microplastics (MPs), oil particulates, heavy metals, inorganic anions, antibiotics, pesticides, organic dyes, nuclear materials, organic pollutants, and/or any other particular micro-substance. The magnetic SCGs 101 can exhibit magnetic properties such that the magnetic SCGs 101 can be directed through any particular magnetic force. The magnetic SCGs 101 can be formed through a green manufacturing approach using spent coffee grounds (“SCGs”) 102. By using SCGs 102, the magnetic SCGs 101 can be readily created from an abundant naturally derived material. The technique 100 can define the various processes performed to create the magnetic SCGs 101. The boxes 100A-E can be performed in any particular order. Some boxes 100A-E can be omitted from the technique 100 to form the magnetic SCGs 101.

The magnetic SCGs 101 can have a distinct advantage over other oil recovery micromotors in that they consist of sustainable SCG biowaste with inherent hydrophobicity and do not require any fuel or require physical deposition or chemical reactions for synthesis. The magnetic SCGs 101 can remain buoyant on the water surface, thus reducing drag and improving oil/water separation efficiency due to the magnetic SCGs 101 hydrophobic interactions with floating oil droplets (or any other particular pollutant). As discussed herein, the magnetic SCGs 101 can be produced by bonding iron oxide nanoparticles (“IONPs”) to the surface of the SCGs 102, which can magnetize the SCGs 102. In addition to enabling magnetically driven motion, which can increase removal efficiency compared to stationary use of the magnetic SCGs 101, the presence of magnetic IONPs 104 on the magnetic SCGs 101 surface can facilitate on-demand recovery of the oil contaminant-laden magnetic SCGs 101.

At box 100A, the technique 100 can include collecting the SCGs 102. The SCGs 102 can include any particular coffee ground that can function as magnetic microbots when combined with iron oxide nanoparticles (IONPs) 104 and/or any particular ferrofluid. The SCGs 102 can include unspent coffee grounds that have been ground for coffee making but have yet to undergo a brewing process. The SCGs 102 can include spent coffee grounds, which have been ground and used in the brewing process. Coffee brewing processes can include but are not limited to drip coffee, French press, espresso, bulk coffee brewing, and/or any other particular type of brewing process. The SCGs 102 can be generated from grinding during the coffee creation process and/or by freeze-drying and milling unused coffee beans. The SCGs 102 can include a size of at least about 300 μm, 300-450 μm, or less than about 450 μm. In some embodiments, the SCGs 102 can include a size of less than 300 μm or more than 450 μm. As will be understood, size, as used herein, can refer to the diameter or length of the SCGs (or other organic material). The SCGs 102 can include a coarse, highly textured surface with heterogeneous porosity and flaky protrusions, which can result in a large specific surface area. The coarse, highly textured surface with heterogeneous porosity and flaky protrusions can make SCGs 102 highly effective for water purification, as the textured surface can enhance contact between the SCGs 102 and the pollutants. The surface texture of the SCGs 102 can further enhance the distribution of IONPs 104 on the surface of the SCGs 102. For example, the IONPs 104 can evenly distribute across the coarse textured surface of the SCGs 102. Though discussed in the context of coffee grounds, the technique 100 can include any naturally derived ground material that has a cellular structure that promotes hydrophobicity and similar particle charge as the SCGs 102 to form a bond with the IONPs 104. For example, the technique 100 can include grinding a naturally derived materials into particulates with a size of at least about 300 μm, 300-450 μm, or less than about 450 μm. In some embodiments, the SCGs 102 can include a size of less than 300 μm or more than 450 μm.

At box 100B, the technique 100 can include dehydrating the SCGs 102. The SCGs 102, for example, can be processed in an oven at 105 degrees Celsius for 48 hours to remove an initial moisture content. Continuing this example, the SCGs 102 can be ground to a desired size (e.g., 450 μm). Further continuing this example, the SCGs 102 can be heated in an oven for at least about 24 hours, 24-48 hours, or less than about 48 hours at about 140 degrees Celsius. In another example, the SCGs 102 can be heated in an oven for at least about 2 hours, 2-4 hours, or less than about 4 hours at about 140 degrees Celsius until the SCGs 102 are completely dehydrated. Any particular combination of time and heat can be used to completely dehydrate the SCGs 102.

At box 100C, the technique 100 can include suspending the SCGs 102 in an alcoholic mixture of IONPs 104 to magnetize the SCGs. For example, the SCGs 102 can be suspended in the alcoholic mixture (e.g., absolute ethanol) with IONPs 104 for at least about 2 hours, 2-4 hours, or less than about 4 hours. The alcoholic mixture with IONPs 104 can include a non-limiting example of 80 mg of IONPs 104 suspended in 6 mL of ethanol. The alcoholic mixture with IONPs 104 can be vortexed for about 30 seconds. The SCGs 102 (e.g., 200 mg of SCGs 102) can be immersed in the alcoholic mixture with IONPs 104 for any particular amount of time such that the IONPs 104 form a bond with the SCGs 102. The IONPs 104 can bind to the surface of the SCGs 102 as a result of hydrogen bonding between the oxygen elements in IONPs 104 and hydroxyl (—OH) functional groups found on the surface of the SCGs 104. On bonding with the IONPs 104, the SCGs 102 can function as the magnetic SCGs 101. As will be understood, prior to magnetizing the SCGs, the SCGs can include ionized properties (e.g., include an electrical charge). By bonding the SCGs with the IONPs to create the magnetic SCGs, the charge of the SCGs can increase.

At box 100D, the technique 100 can include retrieving the magnetic SCGs 101 with a magnetic force (e.g., through a ferromagnet 105 and/or an electromagnet). Prior to or after retrieval, the magnetic SCGs 101 can be strained and washed using ethanol to remove any excess IONPs 104. By coating the SCGs 102 in IONPs 104, the magnetic SCGs 101 can exhibit magnetic properties. For example, in water, the zeta potentials of SCGs 102 and IONPs 104 can be measured to be about −21.7±1.5 mV and −62.3±5.6 mV, respectively. Compared to SCGs 102, the coating of negatively charged IONPs 104 can enhance the negative surface charge on the magnetic SCGs 101, with a measured value of about −42.7±2.5 mV. The increase in the negative surface charge of the magnetic SCGs 101 can lead the magnetic SCGs 101 exhibiting magnetic properties. On exhibiting magnetic properties, the magnetic SCGs 101 can be extracted from the alcoholic mixture using the ferromagnet 105 and/or any other type of magnet (e.g., electromagnet). On extraction the magnetic SCGs 101 can be dried in an oven for 24 hours at 65 degrees Celsius.

At box 100E, the technique 100 can include deploying the magnetic SCGs 101 to clean up oil spills and remove microplastics (MPs) from seawater. For example, Oil droplets 106 and microplastic polystyrene (PS) particles 107 can adhere to the surface of the magnetic SCGs 101 due to the hydrophobic interaction between the magnetic SCGs 101 and the pollutants.

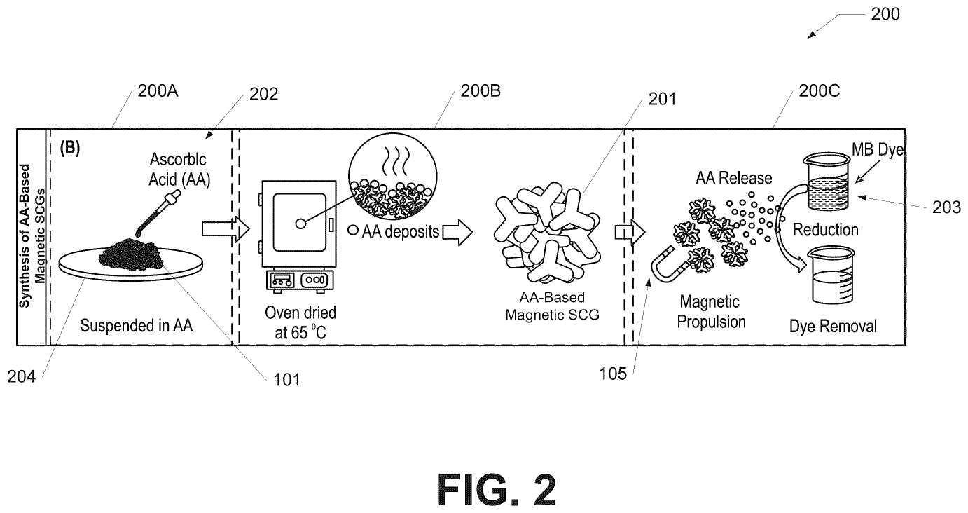

Referring now to FIG. 2, illustrated is an example technique 200 for creating ascorbic-acid (AA)-based magnetic SCGs 201, according to one example of the disclosed technology. The AA-based magnetic SCGs 201 can be defined as magnetic SCGs 101 with an AA coating. The AA-based magnetic SCGs 201 can exhibit the same properties as the magnetic SCGs 101. The AA-based magnetic SCGs 201 can remove dye pollutants and/or other chemical pollutants from a contaminated water source. For example, the AA-based magnetic SCGs 201 can remove debris, microplastics (MPs), oil particulates, heavy metals, inorganic anions, antibiotics, pesticides, organic dyes, nuclear materials, organic pollutants, and/or any other particular micro-substance or chemical from a polluted water source. The technique 200 can illustrate various processes performed to create the AA-based magnetic SCGs 201. Though shown in order, boxes 200A-B can be performed in any particular order. Some boxes 200A-D can be omitted from the technique 200 to form the AA-based magnetic SCGs 201.

At box 200A, the technique 200 can include combining magnetic SCGs 101 with AA molecules 202. For example, the magnetic SCGs 101 can be combined with an AA solution including AA molecules 202, water, and/or ethanol. The mixture can include a non-limiting example of 200 mg of AA molecules 202 dissolved in 5 mL of DI water and 5 mL of ethanol to make a 10 mL solution of 20 mg/mL AA solution. The magnetic SCGs 101 can be placed on a watch glass 204. For example, 60 mg of magnetic SCGs 101 can be placed on the watch glass 204. Continuing this example, the magnetic SCGs 101 can be immersed in 400 μL of the AA solution discussed herein.

At box 200B, the technique 200 can include drying the magnetic SCGs 101 mixed with the AA solution to form the AA-based magnetic SCGs 201. The watch glass 204 can be placed in an oven to dry and form AA-based magnetic SCGs 201. For example, the watch glass 204 with the magnetic SCGs 101 mixed with the AA solution can be placed in an oven at 65° C. for at least about 6 hours, 6-24 hours, or less than about 24 hours to evaporate the solvent and obtain dried samples of AA-based magnetic SCGs 201.

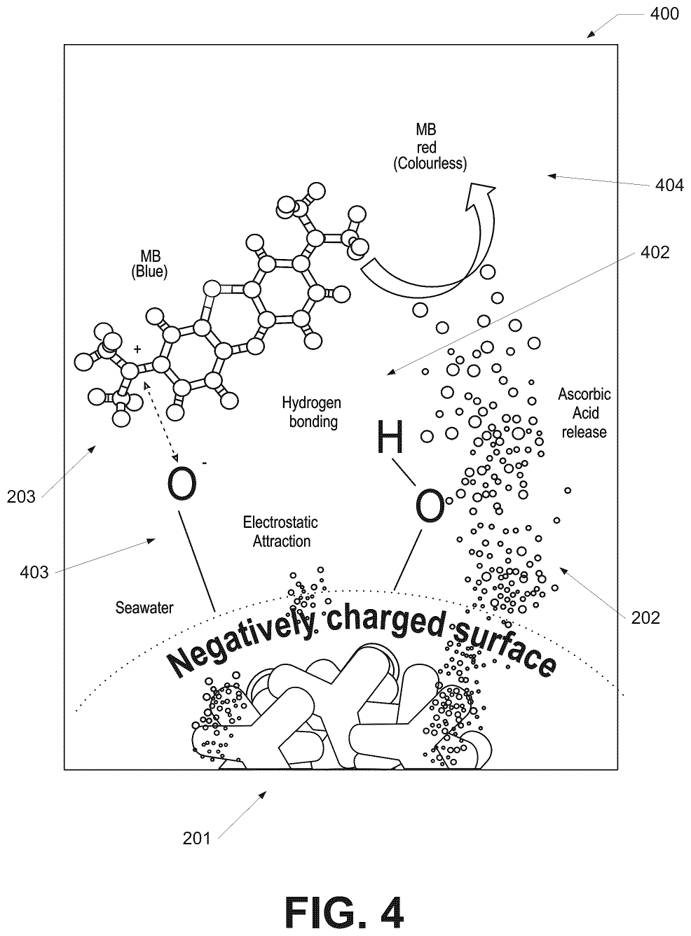

At box 200C, the technique 200 can include deploying the AA-based magnetic SCGs 201 to remove dye pollution from a contaminated water source. When deploying the AA-based magnetic SCGs 201, the negative surface charge of the magnetic SCGs 101 can facilitate MB dye 203 reduction. Additionally, when deployed into a particular water source, the AA-based magnetic SCGs 201 can autonomously release AA molecules 202 to accelerate the rate of MB dye 203 decolorization. The aforementioned characteristics of the AA-based magnetic SCGs 201 can increase the overall rate of dye pollutant removal from the particular water source (see FIG. 4 for further details). The AA-based magnetic SCGs 201 can experience the same magnetic propulsion from the magnet 105 as the magnetic SCGs 101.

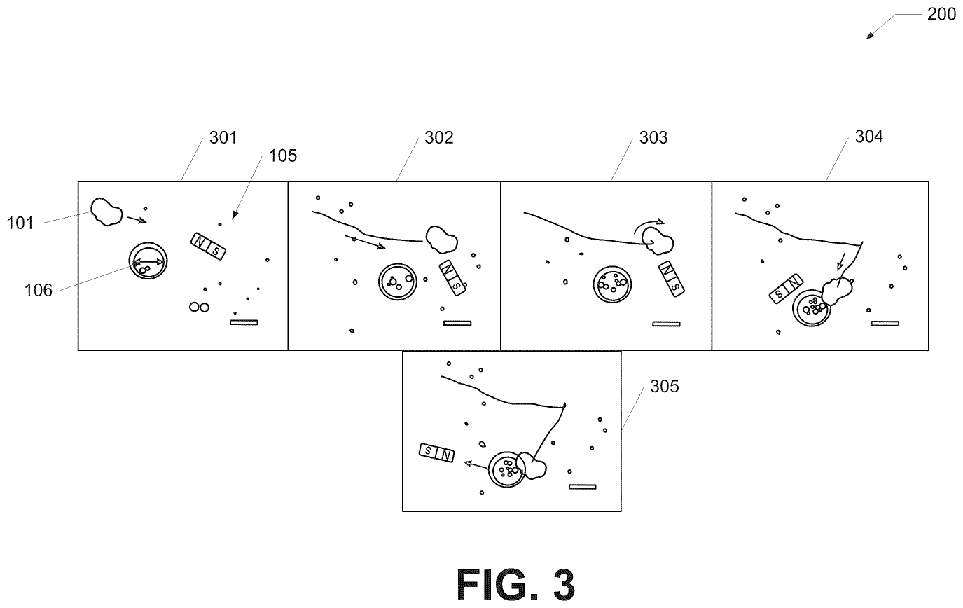

Referring now to FIG. 3, illustrated is an example use case scenario 300 of the magnetic SCGs 101, according to one example of the disclosed technology. The use case scenario 300 can illustrate a technique for removing contaminant particles from a particular water source using one or more magnetic SCGs 101. Due to the magnetic properties of the magnetic SCGs 101, the movement of the magnetic SCGs 101 can be controlled through the magnet 105. For example, the speed and direction of the moving magnetic SCGs 101 can be precisely controlled by an external magnetic field (e.g., with the magnet 105). Continuing this example, the magnetic SCGs 101 can alter their spatial paths by altering the orientation of the magnet 105. The magnetic SCGs 101 can operate at high speeds and follow intricate paths, making them ideal for water purification applications. Movement of the magnetic SCGs 101 can improve the efficiency of water purification as compared to stationary use of the magnetic SCGs 101. As will be understood, movement of the magnetic SCGs 101 in a water source or aqueous solution can be optional.

Boxes 301-305 can illustrate various maneuvers performed by a particular magnetic SCG 101 to collect an oil droplet 105. For example, boxes 301-305 can depict the magnetic actuation of one or more magnetic SCGs 101 in seawater for capturing and transporting a free-floating oil droplet 106. At box 301, the use case scenario 300 can include the magnetic SCG 101 of 450 μm in size retrieving the oil droplet 106 of approximately the same size (e.g., 528 μm). At box 302, the use case scenario 300 can include the magnet 105 directing the magnetic SCG 101 towards the floating oil droplet 106. At box 303, the use case scenario 300 can include rotating the magnetic SCG 101 using the magnet 105. For example, the magnet 105 can re-orient the magnetic SCG 101 by adjusting the position of the magnet 105. At box 304, the use case scenario 300 can include directing the magnetic SCG 101 towards the oil droplet 106 using the magnet 105. At box 305, the use case scenario 300 can include the magnetic SCG 101 contacting the oil droplet 106 and the magnetic SCG 101 capturing and transporting the oil droplet 106 along the predesigned path with high precision. Various magnetic SCGs 101 can be deployed to remove an oil slick, which is a notoriously difficult task for conventional cleaning techniques. For example, the magnetic SCGs 101 can deploy and hydrophobically attach to the oil slick, forming an oil tar clump. Because the magnetic SCGs 101 are buoyant, the oil tar clump can float and can be easily collected using the magnet 105.

The inherent hydrophobicity of magnetic SCGs 101 can facilitate a strong hydrophobic interaction between the oil droplets 106 and the surface of the magnetic SCGs 101. For example, upon coming into contact with the free-floating oil droplets 106, the hydrophobic magnetic SCGs 101 can immediately absorb the oil droplets 106 onto its surface. Continuing this example, the magnetic SCGs 101 can transport the oil droplet 106 from one location to another under the influence of the magnetic field of the magnet 105. Further continuing this example, as the oil droplet 106 engulfs the magnetic SCG 101, the oil droplet 106 and the magnetic SCG 101 can move together as a single entity. The magnetic SCG 101 can collect the oil droplet 106 at any particular speed. For example, the magnetically navigated magnetic SCG 101 can capture a stationary oil droplet 106 while traveling at speeds up to about 600 μm/s, which can correspond to about 1.7 body lengths per second. The oil droplet 106 can remain anchored to the surface of the magnetic SCG 101 while the magnetic SCG 101 is in motion.

The magnetic SCGs 101 can move using a magnetic force, which is an advantage when operating in seawater since the high ionic concentrations severely restrict the self-propulsion of several fuel-based micro-swimmer designs under similar conditions. The magnetic SCGs 101 can vary in velocity based on the intensity of the magnetic force inducing movement in the magnetic SCGs 101. For example, the speed of the magnetic SCGs 101 can increase with an increase in the magnetic field intensity. Continuing this example, the magnetic SCGs 101 can achieve a maximum velocity of about 5500 μm/s, equivalent to about 12 body lengths per second, at 95 mT of magnetic field strength.

The magnetic SCGs 101 can be cleaned in an alcoholic solution for re-use. For example, after each separation experiment cycle, the used magnetic SCGs 101 can be washed with acetone to remove the absorbed oil droplets 106. For successive cycles, the magnetic SCGs can be reintroduced into an oil-water two-phase mixture. During the fabrication process, the magnetic SCGs 101 can be functionalized with additional superhydrophobic entities to remove oil emulsions.

In some examples, the oil droplet 106 can be an MP particle 107 (see FIG. 1). The use case scenario 300 can apply similarly to removing and reducing the MP particle 107. For example, boxes 301-305 can function to describe the techniques for removing MP particles 107 using magnetic SCGs 101. The magnetic SCG 101 can remove the MP particular 107 from a contaminated water source. For example, the MP particles 107 can exhibit a strong attraction to hydrophobic materials, such that the magnetic SCGs 101 can attract the MP particle 107 for removal from the contaminated water source. In such a scenario, the magnetic SCGs 101, after removing MP particles 107, can be washed with ethanol to remove the contaminants and reused for further use.

Referring now to FIG. 4, illustrated is an example use case scenario 300 of the AA-based magnetic SCGs 201, according to one example of the disclosed technology. The magnetic SCGs 101 and/or the AA-based magnetic SCGs 201 can function as a cleaning agent for removing the MB dye 203 and/or other dye pollutants from a contaminated water source. The absorption capabilities of the magnetic SCGs 101 and/or the AA-based magnetic SCGs 201 can increase with increased water alkalinity. The AA-based magnetic SCGs 201 and/or the magnetic SCGs 101 can acquire negative charges when the pH of the contaminated water source is basic, enabling the AA-based magnetic SCGs 201 and/or the magnetic SCGs 101 to electrostatically attract cationic MB dye 203 molecules (e.g., positively charged MB dye 203 molecules). The AA-based magnetic SCGs 201 and/or the magnetic SCGs 101 can interact with the MB dye 203 molecules via hydrogen bonding 402 and electrostatic attraction 403 during an absorption process. Hence, due to their intrinsic negative surface charge, the AA-based magnetic SCGs 201 and/or the magnetic SCGs 101 can electrostatically interact with the cationic MB dyes 203. The presence of hydroxyl (—OH) groups of the AA-based magnetic SCGs 201 and/or the magnetic SCGs 101 can result in the hydrogen bonding 402 with MB dye 203 moieties, thus resulting in MB dye 203 absorption. For the AA-based-magnetic SCGs 201, the negative surface charge of the magnetic SCGs 101 can facilitate an MB dye 203 reduction, while the autonomous release of AA molecules 202 from the AA-based-magnetic SCGs 201 in a particular water source can accelerate the rate of MB dye 203 decolorization, therefore increasing the overall rate of dye pollutant removal from the particular water source.

The high MB dye 203 removal rate caused by the AA-based magnetic SCGs 201 can be attributed to the reduction of MB dyes 203 by ascorbate ions (As²⁻). During the reduction of MB dyes 203 by As²⁻, upon interaction with AA molecules 202, the MB dyes 203 can convert into their reduced state, known as leucomethylene blue (LMB or MB_{red}) 404. While the MB dyes 203 convert into their reduced state, the AA molecules 202 can oxidize, which can result in the formation of dehydroascorbic acid (DHA). The disappearance of the blue color in the MB dye 203 solution can be attributed to the formation of colorless MB_{red} 404 moieties. The AA-based magnetic SCGs 201 can release AA molecules 202 into a contaminated water source with MB dye 203, causing the reduction of MB dyes 203 as discussed herein.

MB_{red} 404 can undergo oxidation, leading to its conversion back into MB dye 203 and consequently recovering the characteristic blue hue. An excess of As²⁻ ions in MB dye 203 solution with a pH just above neutral can adjust the equilibrium kinetics in favor of product formation. This change can restrict the conversion of MB_{red} 404 back into its initial state (e.g., MB dye 203). To impede the transformation of MB_{red} 404 into MB dye 203, and accomplish total reduction of MB dye 203, the magnetic SCGs 101 can be coated in AA molecules 202. The AA-based magnetic SCGs 201 can be coated with an excess amount of AA molecules 202 to impede the transformation of MB_{red} 404 into MB dye 203. For example, the AA-based magnetic SCGs 201 can be coated with at least about 3.3 mg of AA molecules 202, 2.0-4.0 mg of AA molecules 202, or less than about 4.0 mg of AA molecules 202 for each mg of magnetic SCGs 101.

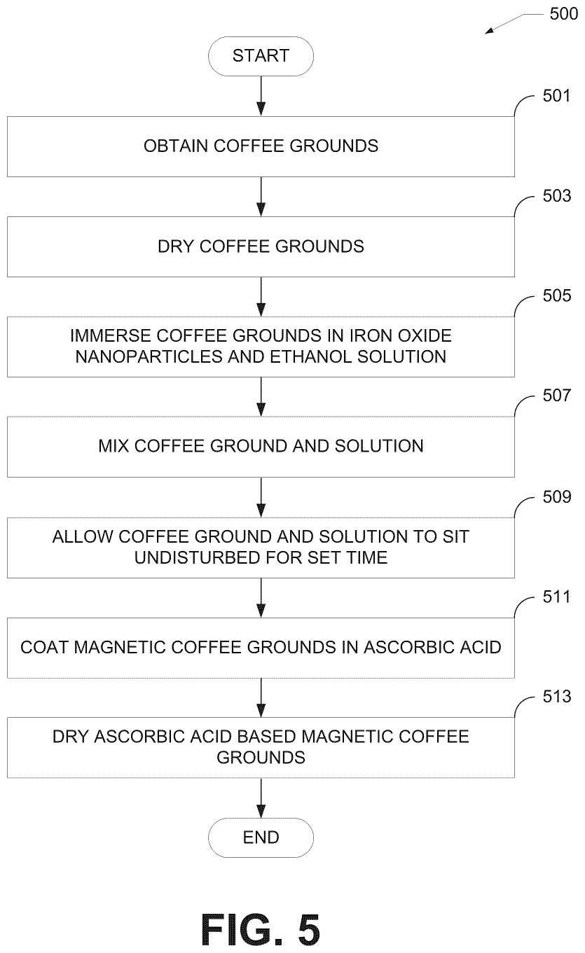

Referring now to FIG. 5, illustrated is a flowchart of a process 500, according to one example of the disclosed technology. The process 500 can describe a technique for creating the AA-based magnetic SCGs 201. Though shown in a particular order, any particular box of the process 500 can be performed in any particular order.

At box 501, the process 500 can include obtaining coffee grounds. The AA-based magnetic SCGs 102 can be formed from spent coffee grounds (e.g., used in a coffee brewing process) or unspent coffee grounds. Any other particular material can be used such that the material exhibits similar hydrophobic and molecular attraction properties as the SCGs 102.

At box 503, the process 500 can include drying the SCGs 102. The SCGs 102, for example, can be processed in an oven at 105 degrees Celsius for 48 hours to remove an initial moisture content. Continuing this example, the SCGs 102 can be ground to a desired size (e.g., 450 μm). Further continuing this example, the SCGs 102 can be heated in an oven for at least about 24 hours, 24-48 hours, or less than about 48 hours at about 140 degrees Celsius. In another example, the SCGs 102 can be heated in an oven for at least about 2 hours, 2-4 hours, or less than about 4 hours at about 140 degrees Celsius until the SCGs 102 are completely dehydrated. Any particular combination of time and heat can be used to completely dehydrate the SCGs 102.

At box 505, the process 500 can include immersing the coffee grounds in a solution of iron oxide nanoparticles and ethanol to magnetize the SCGs. For example, the SCGs 102 can be suspended in the alcoholic mixture (e.g., absolute ethanol) with IONPs 104 for at least about 2 hours, 2-4 hours, or less than about 4 hours. The alcoholic mixture with IONPs 104 can include a non-limiting example of 80 mg of IONPs 104 suspended in 6 mL of ethanol. The alcoholic mixture with IONPs 104 can be vortexed for about 30 seconds. The SCGs 102 (e.g., 200 mg of SCGs 102) can be immersed in the alcoholic mixture with IONPs 104 for any particular amount of time such that the IONPs 104 form a bond with the SCGs 102. The IONPs 104 can bind to the surface of the SCGs 102 as a result of hydrogen bonding between the oxygen elements in IONPs 104 and hydroxyl (—OH) functional groups found on the surface of the SCGs 104. On bonding with the IONPs 104, the SCGs 102 can function as the magnetic SCGs 101. As will be understood, prior to magnetizing the SCGs, the SCGs can include ionized properties (e.g., include an electrical charge). By bonding the SCGs with the IONPs to create the magnetic SCGs, the charge of the SCGs can increase.

At box 507, the process 500 can include mixing the coffee grounds and the solution. For example, 200 mg of SCGs 102 can be immersed in the alcoholic mixture with IONPs 104.

At box 509, the process 500 can include allowing the coffee grounds and the solution to sit undisturbed for a predetermined time period. For example, the SCGs 102 can be suspended in the alcoholic mixture (e.g., absolute ethanol) with IONPs 104 for at least about 2 hours, 2-4 hours, or less than about 4 hours. Boxes 505-509 can describe the magnetization of the SCG 101.

At box 511, the process 500 can include coating the coating the magnetic SCGs 101 (referred to herein as magnetized coffee grounds) with ascorbic acid. For example, the magnetic SCGs 101 can be combined with an AA solution including AA molecules 202, water, and/or ethanol. The mixture can include a non-limiting example of 200 mg of AA molecules 202 dissolved in 5 mL of DI water and 5 mL of ethanol to make a 10 mL solution of 20 mg/mL AA solution. The magnetic SCGs 101 can be placed on a watch glass 204. For example, 60 mg of magnetic SCGs 101 can be placed on the watch glass 204. Continuing this example, the magnetic SCGs 101 can be immersed in 400 μL of the AA solution discussed herein. The magnetic SCGs 101 can be left in the AA solution until the AA forms a coating on the magnetic SCGs 101 and the AA-based magnetic SCGs 201 are formed.

At box 513, the process 500 can include drying the AA-based magnetic SCGs 201. The watch glass 204 can be placed in an oven to dry and form AA-based magnetic SCGs 201. For example, the watch glass 204 with the magnetic SCGs 101 mixed with the AA solution can be placed in an oven at 65° C. for at least about 6 hours, 6-24 hours, or less than about 24 hours to evaporate the solvent and obtain dried samples of AA-based magnetic SCGs 201.

### Experimental Results

The following experimental results are intended to provide non-limiting examples of various technical aspects of the disclosed technology. Any discussion regarding the disclosed technology in this section is not intended to limit the scope of the innovation(s) and is intended to support the theoretical concepts underlining the disclosed technology. The following description can include experimental results from two distinct experimentations directed toward the disclosed technology.

### First Experimentation

### 1. Materials

The espresso coffee grounds were purchased from Cafe Bustelo (brick pack) and brewed once using a Bialetti Moka coffee maker. Iron (II, III) oxide or Magnetite nanoparticles (IONPs, Cat. No: 637106-25G), L-ascorbic acid (AA), molecular biology-grade ethanol (200 proof, Cat. No: E7023-1L), Oil red O dye, and acetone were purchased from Sigma Aldrich (USA). Neodymium (NdFeB) magnets (N52-grade) were purchased from K & J Magnetics (USA). Disposable 100 μm Nylon mesh cell strainer and ultrapure distilled (DI) water were purchased from Fisherbrand (USA) and Invitrogen (USA), respectively. Natural seawater was procured from Carolina Biological supply company (USA). Methylene blue (MB) was purchased from HiMedia Laboratories (USA). Engine oil was procured from Valvoline Inc. (USA). Spherical polystyrene (PS) microbeads (mean particle size: 60 μm) were purchased from Amazon (USA). All the glasswares and Whatman filter papers (Grade 1) were purchased from VWR International (USA). The aforementioned chemicals were used without further purification.

### 2. Characterization Techniques

Field emission scanning electron microscopy (JEOL-IT500HR, USA) was used to examine the samples. The samples were vacuum-dried and placed on carbon tape adhered to a stub and gold-sputtered for FESEM analysis. Gold sputtering was performed at 20 mA ion current for 3 min (1 cycle) using a Denton Vacuum Desk V sputter coater (USA). The sample elemental analysis was measured by energy dispersive X-ray spectroscopy (EDX) in FESEM. The FTIR analyses were performed on a Nicolet iS10 FTIR Spectrometer (Thermo Scientific, USA). Before testing, samples were dried and formed into KBr pellets and the measurements were obtained in the 400-4000 cm-1 spectral range in transmission mode with 64 scans at a resolution of 4 cm−1. The zeta potential (surface charge) and dynamic light scattering (DLS) measurements were performed in Malvern Zetasizer Nano ZS (USA) using DTS-1070 folded capillary zeta cells. The measurements for zeta potential were taken by suspending the samples in 0.1×PBS at pH 7.4. For dye removal experiments, the liquid samples were scanned at 665 nm using a Tecan Safire 2 Microplate Reader (USA), and full range scan was performed using Cary 60 UV-Vis spectrophotometer (Agilent, USA). Microbot motion was captured under the Leica DMi8 inverted microscope with Leica application software (LAS-X) software. Various experiments were conducted by applying a neodymium bar magnet (N-52 grade) with a magnetic field gradient of 109 mT mm−1, and the applied magnetic field was measured with a Tunkia TD8620 Handheld Digital Tesla Meter High Precision Gaussmeter (Amazon, USA).

### 3. Elemental Mapping and IONP Size Distribution

The EDX analysis of the SCG 102 can reveal that it is composed of 54.59% carbon (C), 34.59% oxygen (O), 6.9% nitrogen (N), and trace amounts of sulfur (S) about 0.13%. The EDX analysis of the magnetic SCGs 101 can suggest that the composition of the magnetic SCGs 101 can include 38.72% carbon (C), 31.87% oxygen (O), and 20.45% iron sourced from IONPs, along with smaller percentages of nitrogen (N) at 3.47%, and sulfur (S) traces at 0.37%. In both specimens, the presence of elemental gold (Au) was identified, which can be attributed to the utilization of Au sputtering during FESEM sample preparation. The attachment of aggregates on the surface of the magnetic SCGs can consist of discrete IONPs with sizes varying from 200 nm to 700 nm. The DLS technique was utilized to measure the size of commercial IONPs, which further verified the nanoparticles' size distribution. The average diameter of these particles was approximately 570 nm, with sizes ranging from 200-800 nm.

### 4. Hydrophobicity Test

The measured contact angle between water droplet and Magnetic SCGs 101 is ˜138o, providing evidence of their hydrophobic nature.

### 5. Zeta Potential (Surface Charge) Measurements

The average zeta potential (surface charge) values for SCGs, IONPs, Magnetic SCGs 101 and PS beads were recorded to be −21.7 mV, −62.3 mV, −42.7 mV and −42.1 mV, respectively.

### 6. Velocity Profile Measurements

The variation in speed (Vm) of ˜450 μm Magnetic SCGs 101 with changing external magnetic fields from 95 mT to 15 mT was measured while immersed in seawater at a distance of 2 cm away from the magnetic pole. The microbots moved linearly toward the nearest magnetic pole under magnetic guidance. Under a lower magnetic field strength (15 mT), Magnetic SCGs 101 averaged ˜920 μm s−1, which corresponds to 2 body lengths per second. With a magnetic field strength of 95 mT, Magnetic SCGs 101 could move at an average speed of ˜5500 μm s−1, which corresponds to ˜12 body lengths per second. In addition, the experiments indicated that the motor could be accelerated by further increases in the external magnetic field.

### 7. The Calibration Plot for MB Dye Experiments

The linear correlation between the MB dye concentration and the absorbance peak intensity at 665 nm can be expressed as a linear mathematical equation: A=0.03102 C+0.04861. In order to determine an unknown concentration of MB in seawater, this mathematical expression was used for all the experiments.

### 8. Reusability of AA-Based Magnetic SCGs 201

For reusability tests, AA-based magnetic SCGs 201 were retrieved at the end of the reaction and washed twice with 50% ethanol for removal of surface-absorbed MB dye molecules. The samples were dried at 65° C. for 5 h. The dried samples were placed on a watch glass and were immersed in 400 μL of ascorbic acid solution to reload the sample with ascorbic acid. Following this, the watch glass was then placed in an oven at 65° C. for at least 12 h to evaporate the solvent. The aforesaid method for AA-based magnetic SCGs 201-mediated water treatment was repeated each time followed by reloading of ascorbic acid for five consecutive reusability tests.

### 9. Rate Constant Measurements for MB Dye Experiments

The time-dependent MB dye 203 removal by 50 mg of AA-based magnetic SCGs 201 immersed in 8 mL of seawater with 10 mg/L MB dye contamination was measured. The logarithmic of MB dye 203 concentrations is plotted as a function of the reaction time, where ‘C’ denotes the concentrations of MB dye in the solution at any time, and ‘C0'’ denotes the initial dye concentration of 10 mg/L. The recorded MB dye 203 concentration in the solution fits a straight line, which can indicate that MB dye 203 removal follows first-order kinetic rate law, where slope (k) represents the observed first-order rate constant (in min−1).

### 10. Oil Separation Efficiency (OSE) Calculations and Reusability of Magnetic SCGs

The OSE was determined using following equation stated below:

$$OSE ( \% ) = ( \frac{{W}_{0} - {W}_{1}}{{W}_{0}} ) \times 100.$$

where W₁ is the weight of oil spill (in mg) left on glass slide after clean-up operation, and W₀ is the initial weight (in mg) of the oil droplet. The average data along with standard error bars was recorded using a set of three experiments.

For reusability tests, 30 mg of the magnetic SCGs 101 were introduced onto a droplet of engine oil (25 mg) drop-cast onto a glass slide, followed by a stay for 3 min. After this, the magnetic SCGs 101 were magnetically collected and subsequently by acetone wash. The exhausted motors were suspended in 10 ml of acetone and vortexed for 2 min. Once again, the motors were magnetically retrieved and washed twice with acetone, followed by oven drying at 65° C. for 2 h. For testing its reusability, the magnetic SCGs 101 were again introduced into oil samples, and the process of oil sorption was carried out for five consecutive cycles. The percentage of recovered oil (OSE) after each cycle was calculated as stated previously. Three experiments were used to record the average data and standard error bars.

### 11. Microplastics Removal Efficiency Calculations and Magnetic SCGs Reusability

The removal efficiency of PS beads from seawater was calculated using the following equation:

$$Removal efficiency ( \% ) = ( \frac{{M}_{0} - {M}_{1}}{{M}_{0}} ) \times 100$$

where, M₁ is final mass (in mg) of residual PS beads after filtration, and M₀ is the initial mass (in mg) of the PS beads before treatment. The average data along with standard error bars was recorded using a set of three experiments.

For reusability tests, 10 mg of spherical PS microbeads (20 μm-140 μm) were uniformly dispersed in 8 ml of seawater sample by ultrasonication. 50 mg of magnetic SCGs 101 were added to the contaminated water, followed by 1 hr standby period. After the treatment, a neodymium bar magnet was used to separate microbots from the solution. The retrieved magnetic SCGs 101 were suspended in 10 ml of ethanol and vortexed for 10 min and subsequently the treated solution was filtered using a Whatman filter paper. The retrieved magnetic SCGs 101 and filter paper with remnant PS beads were oven-dried at 80° C. overnight to remove the ethanol and water, respectively. The remnant PS beads were collected and weighed in a precision analytical balance. The dried microbots were again introduced into microplastic-contaminated seawater solution, and the process of removal was carried out for five consecutive cycles. The percentage of microplastic removal after each cycle was calculated as stated previously. Three experiments were used to record the average data and standard error bars.

### Second Experimentation

### 1. Characterization

Using Field emission scanning electron microscopy (FESEM), the surface morphologies of SCGs 102 and magnetic SCGs 101 were examined. The SCGs 102 can have a coarse, highly textured surface with heterogeneous porosity and flaky protrusions, resulting in a large specific surface area.

There is no discernible sign of Fe in the IONPs 104, but for the magnetic SCGs 101, there is a high concentration of metallic Fe present throughout the surface area. This finding can confirm that the functionalization of SCGs 102 with IONPs 104 to form magnetic SCGs 101 can be successfully achieved. A further EDX analysis of the SCGs 102 can show that SCGs 102 can be composed mainly of carbon (C), nitrogen (N), sulfur(S), and oxygen (O) elements. The EDX analysis of the Magnetic SCGs 101 can show the presence of elemental C, N, O, and S as the constituents along with a presence of metallic Fe from IONPs 104 on the magnetic SCGs 101 surface. The FESEM images can further reveal that the observed IONPs 104 aggregates can be comprised of roughly spherical IONPs 104 of diverse sizes varying from 200-700 nm. Dynamic light scattering (DLS) measurements were conducted to revalidate the size distribution of the commercial IONPs 104. Moreover, the magnetic SCGs 101 retain the hydrophobic characteristics of the SCGs 102, displaying hydrophobicity without any additional surface alterations.

To determine the surface charge characteristics of the SCGs 102 and IONPs 104, the zeta potential was measured using electrophoretic light scattering (ELS). The mean zeta potential values of uncoated SCGs 102, IONPs 104, and magnetic SCGs 101 were measured. In water, the zeta potentials of uncoated SCGs 102 and free IONPs 104 were measured to be −21.7±1.5 mV and −62.3±5.6 mV, respectively. Compared to uncoated SCGs 102, the coating of negatively charged IONPs 104 can enhance the negative surface charge on the magnetic SCGs 101, with a measured value of −42.7±2.5 mV.

Since both SCGs 102 and IONPs 104 can possess negative charges, it can be inferred that the binding affinity of IONPs 104 to SCGs 102 may not occur through electrostatic attraction. The evidence can indicate that different intermolecular forces, such as hydrogen bonding, can be responsible for the attractive interactions between SCGs 102 and IONPs 104.

Fourier transform-Infrared (FTIR) spectroscopy was performed on SCGs 102 alone, IONPs 104 alone, and magnetic SCGs 101. The FTIR spectrum of bare SCGs 102, can exhibit all the distinctive peaks. The distinct peak at 3487 cm⁻¹ can be associated with the stretching vibration of free or intermolecular bonded hydroxyl (—OH) groups arising from alcohols, phenols, and carboxylic acids, which constitute the hemicellulose, cellulose, and lignin known to be present in SCGs 102. The distinct peak at 2926 cm⁻¹ can be attributable to asymmetric and symmetric stretching of C—H bonds present in methylene (—CH₂—) and methyl groups (—CH₃), respectively. The occurrence at 2855 cm⁻¹ can imply stretching of aliphatic C—H bonds deriving from the cellulose backbone. The peaks observed at 1746 cm⁻¹ and 1652 cm⁻¹ can pertain to the stretching vibrations of carbonyl (C═O) and carbon-carbon double bonds (C═C), respectively. These vibrational modes can be associated with caffeine, hemicellulose, and chlorogenic acid molecules. The peaks located at 1,471 cm⁻¹ and 1,370 cm⁻¹ can be ascribed to the β (1→4) linkage in non-crystalline cellulose. In the FTIR spectrum for IONPs 104, the vibrational bending of Fe—O in magnetite (Fe₃O₄) accounted for the peaks observed at 678 cm⁻¹ and 568 cm⁻¹.

The FT-IR spectrum of the magnetic SCGs 101 was measured. The data can demonstrate that the introduction of IONPs 104 to the SCGs 102 can result in a marked shift in the —OH peak from 3487 cm⁻¹ to 3432 cm⁻¹. The alteration suggests that the —OH functional groups present in SCGs 102 can play a role in binding with IONPs 104.

Within the widened C═O spectral absorption band at 1741 cm⁻¹ for magnetic SCGs 101, a weak peak can appear around 1712 cm⁻¹. This peak appears neither in the pure SCG 102 nor in the pure IONP 104 spectrum. The conclusive peak for hydrogen bonding may be seen in the 1700-1720 cm⁻¹ range. Thus, the weak peak observed at 1712 cm⁻¹ can be ascribed to the intermolecular interaction induced by hydrogen bonding between SCGs 102 and IONPs 104. The alteration observed in the-OH peak, widening of C═O peak, and appearance peak around 1712 cm⁻¹ may be accounted for the interaction occurring between the oxygen (O) moieties of IONPs 104 and the functional groups bearing hydroxyl (—OH), namely alcohols, phenols, and carboxylic acids, that are present in SCGs 101. The peaks for C—H (2922 and 2850 cm⁻¹), C═C (1648 cm⁻¹), and β (1→4) linkage of cellulose (1455 and 1370 cm⁻¹), can arise from SCGs 102 present in the FT-IR spectrum of magnetic SCGs 101, while the peak at 562 cm⁻¹ can be indicative of Fe—O vibrational bending of the incorporated IONPs 104.

### 2. Motion Control Experiments

To identify the salient features of the magnetically induced motion, a series of experiments was performed employing a ˜450 μm magnetic SCGs 101 inside a bath of seawater. The velocity of the Magnetic SCGs 101 can increase significantly with the increase in magnetic field intensity, achieving a maximum velocity of ˜5500 μm/s, equivalent to ˜12 body lengths per second, at 95 mT of magnetic field strength.

### 3. Organic Dye Decontamination

In this context, 50 mg of magnetic SCGs 101 were suspended in 8 mL of MB solution (10 mg/L) in seawater. To estimate the MB dye 203 removal rate, the aliquots were drawn at respective time intervals and the absorbance of the samples was measured at λₘₐₓ=665 nm using a Tecan microplate reader. After 40 min of treatment, magnetic SCGs 101 depleted the MB dye 203 concentration from 10 mg/L to ˜5.39 mg/L, which corresponds to ˜46% of MB dye 203 removal. Control experiments were conducted by suspending 50 mg of uncoated SCGs 102 in 8 mL of 10 mg/L MB solution. A 40-min treatment with uncoated SCGs 102 decreased the MB dye 203 concentration from 10 mg/L to ˜5.2 mg/L, corresponding to ˜48% dye removal. The MB dye 203 removal rate with a rate constant of ˜0.016 min⁻¹ was recorded for both uncoated SCGs 102 and magnetic SCGs 101 treatments. The decrease in MB dye 203 concentration in both cases can be attributed to the absorption of MB dye 203 on the surface of the SCGs 102 and magnetic SCGs 101 for 40 min treatment. In the presence of indoor light, the MB dye 203 solution can remain stable after 40 min without particles (No SCGs 102), negating the role of light-induced degradation.

For AA-based magnetic SCGs 201, the negative surface charge of the magnetic SCGs 101 can facilitate the MB dye 203 reduction, while the autonomous release of AA in seawater can accelerate the rate of MB dye 203 decolorization. The MB dye 203 removal rate can mainly be attributed to the reduction of MB dye 203 by ascorbate ions (As²⁻). Magnetic SCGs 101 can be coated with an excess amount of AA, which can equal ˜3.3 mg of AA for each mg of the magnetic SCGs 101. Subsequently, AA-based magnetic SCGs 201 were immersed in 8 mL of seawater polluted with 10 mg/L MB dye 203, and the AA-based magnetic SCGs 201 were rendered stationary or static by placing a bar magnet near the reaction vessel. For motile AA-based magnetic SCGs 201, a bar magnet was used to steer the AA-based magnetic SCGs 201 in the reaction vessel for 40 min. A rapid discoloration of the dye took place in a span of 40 min by administering motile AA-based magnetic SCGs 201. Both stationary and motile AA-based magnetic SCGs 201 can reduce the MB dye 203 concentration from 10 mg/L to ˜2.65 mg/L and ˜0.75 mg/L after 40 min treatment, which can correspond to ˜74% and ˜93% of MB dye 203 removal, respectively.

The time-dependent MB dye 203 reduction using 50 mg of motile AA-based magnetic SCGs 201 suspended in 8 mL seawater containing 10 mg/L MB dye was measured. The magnetic SCGs 101 were veered into vials by controlling the orientation of a bar magnet, and they were retrieved after remediation. A rate constant of ˜0.034 min⁻¹ was observed for stationary AA-based magnetic SCGs 201 and ˜0.072 min⁻¹ for motile AA-based magnetic SCGs 201. At any given point in time, static AA-based magnetic SCGs 101 removed less MB dye 203 than their motile counterparts. These results can indicate that the magnetically-driven motion of magnetic SCGs 101 can enhance mass transfer of MB dye 203 to the surface of the magnetic SCGs 101.

The elimination of MB dye 203 from seawater by employing varying quantities of AA-based magnetic SCGs 201 was measured. After 40 min of treatment, 50 mg of AA-based magnetic SCGs 201 can eliminate ˜93% of MB dye 203, whereas 10 mg of AA-based magnetic SCGs 201 can only managed to remove about 15% of the MB dye 203. The maximum removal efficiency was observed when AA-based magnetic SCGs 201 were used at an amount of 50 mg in 8 mL of 10 mg/L dye.

Moreover, 50 mg of AA-based magnetic SCGs 201 underwent successive degradation trials over five rounds to assess their capacity for reuse in eliminating a concentration of 10 mg/L from seawater within a treatment duration of 40 min. After each experimental cycle, AA-based magnetic SCGs 201 were magnetically retrieved from seawater and regenerated. After five cycles, about ˜8% loss of MB dye 203 decontamination efficiency was observed in this study. The results showed that the AA-based magnetic SCGs 201 can retain their efficiency for removing MB dye 203 even after multiple cycles, suggesting that they could be reused after repetitive AA functionalization.

### 4. Oil-Spill Cleanup and Recovery

A ˜400 μm Magnetic SCGs 101 was employed to retrieve an engine oil droplet 106 of nearly the same size (˜528 μm) drifting freely in seawater. After contacting the oil droplet 106, the magnetic SCGs 101 can capture and transport it along the predesigned path with high precision. The magnetic SCGs 101 was re-oriented by adjusting the position of the magnet, followed by capture and conveyance under magnetic control. The hydrophobicity of the magnetic SCGs 101 can facilitate a hydrophobic interaction between the oil droplets 106 and the surface of the magnetic SCG 101. Upon coming into contact with the free-floating oil droplets 106, the hydrophobic magnetic SCGs 101 can absorb the oil droplets 106 onto its surface. As the Magnetic SCGs 101 transport the oil droplet 106 from one location to another under the influence of the magnetic field, the oil droplet 106 can engulf the magnetic SCG 101 as they move together as a single entity. The magnetically navigated magnetic SCGs 101 (˜350 μm) can capture a stationary oil droplet 106 (˜352 μm) while travelling at high speed up to ˜600 μm/s, which corresponds to ˜1.7 body lengths per second, whereas the oil droplet 106 can remain anchored to the motor surface while in motion.

Furthermore, a collection of Magnetic SCGs 101 (8 mg) of varying size, ranging from 300-450 μm, were deployed in a Petri dish (9 cm diameter) to demonstrate retrieval of floating oil contaminants on a macroscopic scale. The disc-like magnetic SCGs 101 swarm was magnetically actuated in 20 mL of seawater to capture a macroscale oil drop with a diameter of 0.6 cm. By utilizing magnetic forces, the magnetic SCGs 101 swarm can navigate towards the affected area simultaneously to eliminate the spill. The magnetic SCGs 101 swarm can absorb the entire oil spill by hydrophobic interaction in a fraction of seconds.

A magnetic swarm (40 mg) comprising of varying size magnetic SCGs 101, ranging from 300-450 μm, was deployed in a 10 mL beaker to retrieve a floating oil slick from the surface of the seawater. The oil sample (30 μL) was placed on the surface of seawater in a beaker, generating two distinct phases that replicate an oil spill scenario without emulsification. Oil sorption can happen quickly, within 2 min of magnetic SCGs 101-oil interaction, via hydrophobic interactions with the surface of the magnetic SCGs 101 and the freely floating oil slick. At the end of the operation, the Magnetic SCGs 101 were easily recovered by a bar magnet as an alternative to filtration.

To investigate the oil absorption capability and reusability of the magnetic SCGs 101, the oil separation efficiency (OSE) was determined by a series of experiments. Experimentation can demonstrate the oil separation efficiency or OSE 34% of the varying amounts of magnetic SCGs 101 (in mg) when subjected to the removal of oil slicks, for a time span of 3 min. The results of this study showed that OSE increased monotonically with the increment in the amount of magnetic SCGs 101 (in mg) subjected to oil decontamination. It was found that 5 mg of magnetic SCGs 101 can be successful in removing ˜31% of oil contamination as a result of the operation. In addition to increasing the number of magnetic SCGs 101 beyond 5 mg, we also found that when 30 mg of micromotors were used for a prolonged period of 3 min, the OSE improved to ˜99%.

After each separation experiment cycle, exhausted magnetic SCGs 101 were washed with acetone to remove the absorbed oil. For successive cycles, the magnetic SCGs 101 are reintroduced into the oil-water two-phase mixture. The results show that the Magnetic SCGs 101 can maintain their absorption efficiency above ˜80% after five cycles. However, it was observed that OSE declined by about ˜15.6% after five cycles.

### 5. Microplastics Trapping

Magnetic SCGs 101 were deployed for the removal of extremely fine unmodified polystyrene (PS) microbeads from seawater. PS were selected as model MP 107 pollutant as previous studies attribute PS microparticles account for 10% of the plastic particles in untreated water and sediment. To analyse the feasibility of clearing MP pollutants, magnetic SCGs 101 were mixed with PS microspheres in seawater and exposed to a magnetic field.

Magnetic SCGs 101 can demonstrate physical absorption of PS beads governed by their hydrophobic interaction. Magnetic SCGs 101 and PS beads can exhibit nearly equal zeta potentials of −42.7±2.5 mV and −42.1±2.9 mV, respectively, which can eliminate the chances of electrostatic attraction between them. In a series of experiments, different quantities of magnetic SCGs 101 were employed to quantify the removal of MPs 107 through hydrophobic interactions. 10 mg of magnetic SCGs 101 can remove only ˜6% of PS beads after 1 h treatment, but when 50 mg of micromotors were employed, the removal efficiency increased to 64% after 1 hr.

50 mg of magnetic SCGs 101 were introduced in seawater and mixed with 10 mg of PS beads. Upon completion of the experiment, magnetic SCGs 101 were using magnetically retrieved and regenerated by ethanol wash. To determine the reusability of magnetic SCGs 101 for MP removal, a series of experiments was conducted wherein the magnetic SCGs 101 were suspended into MP-polluted seawater for each subsequent repetition. The results of the study show that the magnetic SCGs 101 can maintain a removal efficiency of over ˜55% after five cycles of operation.

### 6. Synthesis of Magnetic SCGs 101

In one non-limiting example, the following steps were performed to ionize SCGs 101 and generate the magnetic SCGs 101. SCGs 101 were Café Bustelo brand coffee grounds purchased at a local supermarket and brewed using a Bialetti Express Moka 6-Cup. After brewing, the SCGs 101 were heated for 48 h in an oven at 105° C., then they were grinded in a mortar and pestle to obtain finer particles. To remove the remaining moisture, SCGs 101 were further dried at 140° C. for 24 h. After this, 200 mg of dried SCGs 101 were transferred to a 20 mL beaker. 80 mg IONPs 104 were suspended in 6 mL of ethanol and the solution was vortexed for 30 s. The IONP 104 solution was poured immediately into the 20 mL beaker containing SCGs 101 and mixed with a spatula. The beaker was left undisturbed for 2 h. The solution was passed through 100 μm strainer to obtain magnetic SCGs 101, followed by ethanol wash to remove the unbound IONPs 104. The filtrate was discarded, and the residue was scooped out of the strainer, and resuspended in 10 mL beaker for final ethanol wash. The samples were magnetically retrieved from ethanol suspension and transferred to a watch glass. The watch glass was placed inside an oven at 65° C. for 24 h to evaporate the remaining ethanol and obtain dried Magnetic SCGs 101. Magnetically-responsive magnetic SCGs 101 were stored at room temperature for further use.

### 7. Synthesis of AA-Based Magnetic SCGs 101

In one non-limiting example, the following steps were performed to generate the AA-based magnetic SCGs 101. 200 mg of AA was dissolved in 5 mL of DI water and then 5 mL of ethanol was added to make a 10 mL of 20 mg/mL AA solution. 60 mg of magnetic SCGs 101 were placed on a watch glass and the particles were immersed in 400 μL of AA solution. Following this, the watch glass was placed in an oven at 65° C. overnight to evaporate the solvent and obtain dried sample. The AA-based magnetic SCGs 101 were freshly prepared before the start of each experiment.

### 8. Magnetic Control and Motion Characterization

Magnetic SCGs 101 were magnetically guided in predefined trajectories using a magnet 105 placed below the set-up, while they were suspended in a Petri dish (35 mm diameter) containing seawater. The magnet 105 was manually moved to control magnetic SCGs 101 motion. As a single magnetic SCGs 101 or in swarms, magnetic SCGs 101 can move along the direction of the external magnetic field. The motion was observed at room temperature under an optical microscope equipped with a CCD or smartphone camera. To evaluate the speed of the magnetic SCGs 101, their displacement was measured from the initial point to the final position per unit of time. The magnetic SCGs 101 were suspended in a Petri dish filled with seawater to measure velocity under magnetic influence.

### 9. Oil Remediation

Oil red O dye (0.5 mg/mL) was added to engine oil for better visibility of oil droplets. The oil separation efficiency (OSE) by an assembly of magnetic SCGs 101 was investigated at room temperature. To test the maximum oil absorption by magnetic SCGs 101, a droplet of engine oil (25 μL) was drop-casted on a glass slide and weighed using a precise analytical balance. A definite amount of magnetic SCGs 101 (in mg) was added to 25 mg (μL) of oil, followed by a stay for 3 min. After this, the exhausted magnetic SCGs 101 were magnetically retrieved from the oil, and the remnant oil slick on the glass was weighed and recorded. The OSE was determined by the percentage of weight loss of the oil droplet from the glass slide after absorption by magnetic SCGs 101 to the initial weight of the oil. The OSE calculations and experimental procedures for magnetic SCGs 101 regeneration reported in the SI.

### 10. Capture of Plastic Microbeads

10 mg of spherical PS microbeads (20-140 μm) were uniformly dispersed in 8 mL of seawater sample by ultrasonication. A definite mass of magnetic SCGs 101 were added to the contaminated seawater, followed by 1 hr standby period. Following the treatment process, magnetic SCGs 101 were magnetically retrieved from the solution. The treated solution was filtered using a Whatman filter paper. The filter paper was dried overnight at 80° C. to remove the water content from the remnant microbeads. To calculate the weight difference after treatment, the beads were collected and weighed using a precise analytical scale. The efficiency of removal was derived by calculating the percentage of weight loss of PS beads after treatment relative to their initial mass.

### 11. Organic Dye Removal

Firstly, dye solution of varying concentrations ranging from 0 to 12 mg/L was prepared by dissolving the MB dye 203 powder in seawater. The standard curve of MB dye 203 was obtained using a microplate reader at 665 nm.

For dye removal experiments, 50 mg of AA-based magnetic SCGs 101 was added to 8 mL of an MB dye 203 solution (10 mg/L dye in seawater) in a 10 mL beaker. For each independent set of experiments, the AA-based magnetic SCGs 101 were magnetically actuated inside the reaction vessel for various time intervals. After a specific time period, the magnet was placed near the beaker to trap the AA-based magnetic SCGs 101 at one side, and 350 μL of aliquot was retrieved. The aliquot was transferred to a 1.5 mL of centrifuge tube, followed by centrifugation at 14000 rpm for 2 min to eliminate suspended particles, if any. After centrifugation, 300 μL of MB dye 203 solution was transferred into a 96-well microplate for absorbance analysis. The MB dye 203 concentration was monitored by recording the absorption peak intensity at 665 nm using a microplate reader. Similarly, the additional experiments were performed for motile AA-based magnetic SCGs 101 of varying amounts (10-50 mg), uncoated SCGs 102, magnetic SCGs 101, stationary AA-based magnetic SCGs 101, and in absence of any particles (No SCGs 102).

The foregoing description of the present systems and processes has been presented only for the purposes of illustration and description and is not intended to be exhaustive or to limit the innovations to the precise forms disclosed. Many modifications and variations are possible in light of the above teaching.

The examples of the present systems and processes were chosen and described in order to explain the principles of the claimed innovations and their practical application so as to enable others skilled in the art to utilize the innovations and various examples with various modifications as are suited to the particular use contemplated. Alternative examples of the disclosed technology will become apparent to those skilled in the art to which the claimed innovations pertain without departing from their spirit and scope. Accordingly, the scope of the claimed innovations is defined by the appended claims rather than the foregoing description and the examples described therein.

What is claimed is:

1. A method, comprising:
obtaining coffee grounds;
magnetizing the coffee grounds; and
coating the magnetized coffee grounds with ascorbic acid.

2. The method of claim 1, wherein magnetizing the coffee grounds comprises:
immersing the coffee grounds in a solution of iron oxide nanoparticles and ethanol;
mixing the coffee grounds and the solution; and
allowing the coffee grounds and the solution to sit undisturbed for a predetermined time period.

3. The method of claim 2, wherein:
the coffee grounds comprise about 200 milligrams by weight; and
the solution comprises about 6 milliliters of the ethanol and about 80 milligrams of the iron oxide nanoparticles.

4. The method of claim 2, further comprising:
straining the magnetized coffee grounds from the solution;
washing the magnetized coffee grounds with an ethanol wash;
suspending the magnetized coffee grounds in an ethanol solution; and
retrieving the magnetized coffee grounds with a magnetic force, wherein the magnetic force interacts with the iron oxide nanoparticles.

5. The method of claim 1, further comprising:
prior to magnetizing the coffee grounds, grinding the coffee grounds to a size between about 300 micrometers and about 450 micrometers; and
drying the coffee grounds at about 140 degrees Celsius for at least 24 hours.

6. The method of claim 1, wherein coating the magnetized coffee grounds with the ascorbic acid comprises:
dissolving the ascorbic acid in a solution of water and ethanol; and
immersing the magnetized coffee grounds in the solution.

7. The method of claim 6, wherein:
the ascorbic acid comprises about 200 milligrams by weight;
the solution comprising about 5 milliliters of the water and about 5 milliliters of the ethanol; and
the magnetized coffee grounds comprise about 60 milligrams by weight.

8. The method of claim 6, further comprising drying the magnetized coffee grounds at about 65 degrees Celsius for at least 12 hours.

9. The method of claim 1, wherein the coffee grounds comprise spent coffee grounds that have undergone a coffee brewing process.

10. A composition, comprising:
coffee grounds and iron oxide nanoparticles, wherein the coffee grounds are coated in ascorbic acid.

11. The composition of claim 10, wherein the coffee grounds are bonded to the iron oxide nanoparticles by hydrogen bonds.

12. The composition of claim 10, wherein the composition is produced by a process of:
obtaining the coffee grounds comprising spent coffee grounds that have undergone a coffee brewing process;
magnetizing the coffee grounds with the iron oxide nanoparticles; and
coating the magnetizing coffee grounds with the ascorbic acid.

13. The composition of claim 12, wherein the composition is produced by the process further comprising:
prior to magnetizing the coffee grounds, grinding the coffee grounds to a size between about 300 micrometers and about 450 micrometers; and
drying the coffee grounds at about 140 degrees Celsius for at least 24 hours.

14. The composition of claim 12, wherein coating the magnetizing coffee grounds with the ascorbic acid comprises:
dissolving the ascorbic acid in a solution of water and ethanol; and
immersing the magnetizing coffee grounds in the solution.

15. The composition of claim 10, wherein the coffee grounds are configured to remove at least one contaminant from an aqueous solution by causing movement of the coffee grounds in the aqueous solution using a magnetized force.

16. A method of using magnetized coffee grounds to remove at least one contaminant from an aqueous solution comprising:
obtaining the magnetized coffee grounds comprising coffee grounds bonded to iron oxide nanoparticles;
immersing the magnetized coffee grounds in the aqueous solution comprising the at least one contaminant; and
removing the at least one contaminant from the aqueous solution by causing movement of the magnetized coffee grounds in the aqueous solution using a magnetized force.

17. The method of claim 16, wherein the at least one contaminant comprises an oil or a microplastic.

18. The method of claim 16, wherein the magnetized force interacts with the iron oxide nanoparticles.

19. The method of claim 16, wherein the magnetized coffee grounds are coated in ascorbic acid and the at least one contaminant comprises a dye.

20. The method of claim 16, wherein coffee grounds comprise spent coffee grounds that have undergone a coffee brewing process.
